(19) United States
(12) Patent Application Publication
(10) Pub. No.: US 2008/0113163 A1
(43) Pub. Date: May 15, 2008

(54) Thermal barrier coating for combustor panels

(75) Inventors: Kevin W. Schlichting, Storrs, CT (US); David A. Litton, Rocky Hill, CT (US); Edward F. Pietraszkiewicz, Southington, CT (US); Melvin Freling, West Hartford, CT (US); James A. Dierberger, Hebron, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/599,674

(22) Filed: Nov. 14, 2006

(51) Int. Cl. B32B 15/00; B05D 1/32; C23C 4/00; B32B 9/04

(52) U.S. Cl. 428/209; 427/259; 427/448; 428/195.1

(57) ABSTRACT

A method is disclosed that selectively applies thermal barrier coatings that exhibit different degrees of thermal conductivity to different inner surface areas of engine combustor panels. Different types of TBCs are applied to predetermined inner surface areas of a combustor panel based on empirical observation or prediction. TBCs exhibiting low thermal conductivity are applied to combustor panel areas that are exposed to hotter temperatures and TBCs exhibiting higher thermal conductivity are applied to areas that are exposed to lower temperatures.

### BACKGROUND OF THE INVENTION

The invention relates generally to the field of gas turbine engines. More specifically, the invention relates to methods of selectively applying thermal barrier coatings that exhibit different degrees of thermal conductivity to different inner surface areas of combustor panels in gas turbine engines to obviate thermo-mechanical fatigue (TMF).

To control engine combustion, large amounts of air are added at specific locations in the combustor. To facilitate this, several rows of combustor panels have dilution holes therein. These holes add air to adjust the stoichiometry of the combustion process. The addition of these “air jets” in the middle of a combustor panel disrupts the film cooling that is being supplied from an upstream combustor panel. As a result, the combustor panel area following a dilution hole does not receive this film cooling and a “hot spot” may result. A current distress mode witnessed on some combustor panels is a hot spot in the center of the panel following a dilution hole that is prone to oxidation and/or cracking.

The hot spot causes local high metal temperatures and an immediate thermal gradient since the surrounding areas of the panel are cooled to a lower temperature. These hot zones contribute to spallation of the thermal barrier coating (TBC) and oxidation of the exposed, underlying base metal. If the TBC is eroded, the thermal gradients between hot and cold regions are exacerbated and thermo-mechanical fatigue (TMF) cracking of the base metal occurs. Therefore, ways of minimizing or eliminating these hot spots are needed.

### SUMMARY OF THE INVENTION

Although there are various methods for protecting gas turbine combustor panels from temperature related problems, such methods are not completely satisfactory. The inventors have discovered that it would be desirable to have methods that selectively apply thermal barrier coatings that exhibit different degrees of thermal conductivity to different inner surface areas of engine combustor panels. Different types of TBCs are applied to predetermined areas of a combustor panel based on empirical observation or prediction. TBCs exhibiting low thermal conductivity are applied to combustor panel areas that are exposed to hotter temperatures, and TBCs exhibiting higher thermal conductivity are applied to areas that are exposed to lower temperatures.

Embodiments of the invention provide methods for obviating temperature gradients across a surface of a substrate. These methods comprise identifying distressed areas on the substrate, applying a first mask to first areas of the substrate, applying a first ceramic coating having a first predetermined thermal conductivity onto the first unmasked areas of the substrate, removing the first mask, applying a second mask to second areas of the substrate, applying a second ceramic coating having a second predetermined thermal conductivity onto the second unmasked areas of the substrate, and removing the second mask.

Other embodiments of the invention provide methods for obviating temperature gradients across a surface of a substrate. These methods comprise identifying distressed areas on the substrate, applying a first ceramic coating having a first predetermined thermal conductivity onto first areas of the substrate, and applying a second ceramic coating having a second predetermined thermal conductivity onto second areas of the substrate.

Other embodiments of the invention provide components for a gas turbine engine. These components comprise a substrate, and at least two thermal barrier coatings, wherein each thermal barrier coating is deposited onto the substrate in a preselected area and each thermal barrier coating exhibits a different thermal conductivity.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary combustor floatwall panel arrangement.

FIG. 2 is an exemplary combustor floatwall panel having a plurality of thermal barrier coatings applied.

FIG. 3 is an exemplary method of the invention.

FIG. 4 is another exemplary method of the invention.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Embodiments of the invention describe methods for selectively applying ceramic thermal barrier coatings (TBC) that exhibit different degrees of thermal conductivity to different inner surface areas of gas turbine engine combustor panels. Since eliminating dilution holes is not feasible, selectively using low thermal conductivity TBCs with high insulating capability provides a solution to obviate the distress mode.

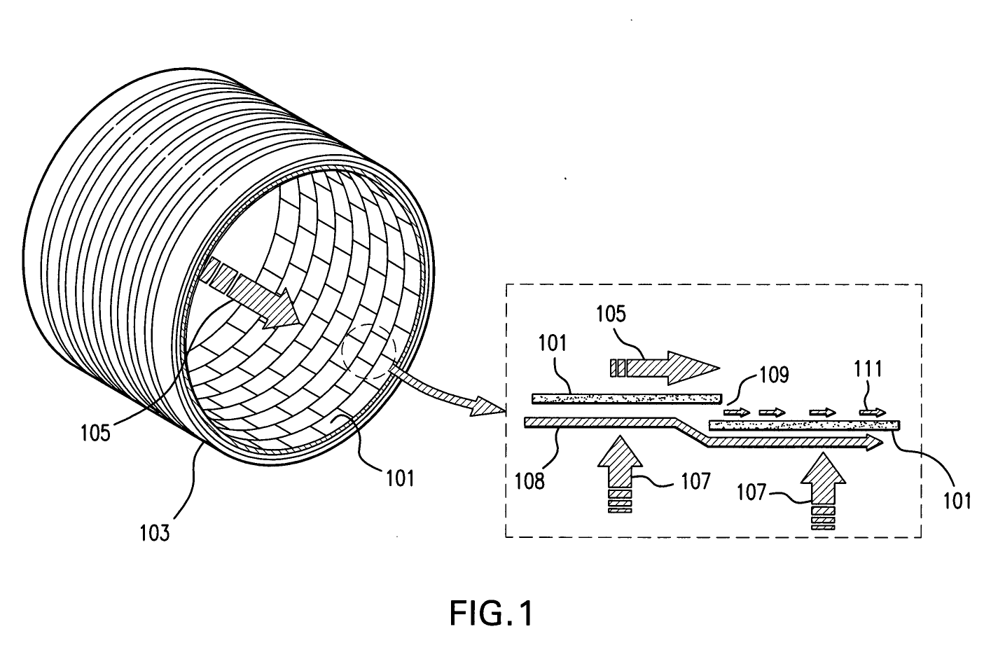

An exemplary floatwall combustor panel arrangement is shown in FIG. 1. Floatwall combustor panels 101 are arranged in the combustor 103 similar to roof singles, where an upstream panel partially overlaps a downstream panel. The panels 101 are attached to a shell 108 which provides the framework for the combustor and regulates cooling air to the backside of the panels 101. To cool the panels 101 from the hot combustion gas path 105, air 107 from the engine compressor is directed through the combustor shell 108 and behind the combustor panels 101. This high pressure air 107 washes over the back surfaces of the panels 101, effectively cooling them, and is expelled into the hot gas stream 105 by exiting along each panel's trailing edge 109. The exiting air creates a film of cooling air 111 along the inner surface of the adjacent downstream panel 101, which protects it from the hot gas stream 105. The backs of the panels 101 are covered with small pins (not shown) that increase the surface area of the panel 101 that is in contact with the cooling air 107, thereby increasing heat transfer from the panel 101 to the cooling air 107 by convection.

Combustor panels 101 are typically made from nickel and/or cobalt-based superalloys using investment casting to produce an equiaxed microstructure. However materials such as single crystal alloys, refractory metal alloys, ceramic based alloys, and ceramic matrix composites could also be used. The hot gas path sides of combustor panels are typically coated with a metallic bondcoat and/or a ceramic TBC to increase durability. The metallic bondcoats are typically NiCoCrAlY compositions produced by air plasma spraying, low pressure plasma spraying, or vacuum plasma spraying, and are typically about 2 to 15 mils thick. Ceramic TBCs, which overlay the metallic bondcoat, are typically anywhere from about 10 to 50 mils in thickness and can reduce metal temperatures up to about 400° F. In some applications, combustor panels require TBCs to achieve an expected part life. For current TBC systems, the TBC is typically applied using an air plasma-spray (APS) process or electron beam physical vapor deposition (EB-PVD). Typical TBCs include, but are not limited to, yttria stabilized zirconia containing about 5 to 25 weight percent of yttria. In some cases, the zirconia is stabilized by additives other than yttria. These additives include ceria, india, scandia, lanthana, ceria, praesodymia, neodymia, promethia, europia, samaria, gadolinia, terbia, dysprosia, holmia, erbia, thullia, ytterbia, and lutetia. The compositions of these latter additives range from about 5 to 70 weight percent, with the remainder being zirconia. This latter group of TBCs with additives other than yttria typically has lower thermal conductivity than yttria stabilized zirconia TBCs, especially when the additive oxide content is between about 30 to 70 weight percent.

Prior to applying any of the TBCs, a metallic bondcoat, typically a McrAlY composition such as NiCoCrAlY, may be applied to the inner surface of the combustor panel. The metallic bondcoat may be applied by any method capable of producing a dense, uniform, adherent coating of the desired composition, such as, an overlay bondcoat, diffusion bondcoat, cathodic arc bondcoat, and others. Such techniques may include, diffusion processes (e.g., inward, outward, etc.), low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, and others.

A low thermal conductivity TBC may then be applied on top of the metallic bondcoat around and downstream of a predicted or identified hot spot region or dilution hole on an inner surface of a combustor panel to improve thermal resistance in high heat flux areas.

A higher thermal conductivity TBC may then be applied on top of the metallic bondcoat of all other exposed inner surface areas to minimize thermal gradients and to maintain an even temperature across a combustor panel. In embodiments, the low thermal conductivity TBCs have about 50 to 60% of the thermal conductivity of the higher conductivity TBCs.

The TBCs are typically applied using either EB-PVD or APS, however other techniques such as slurry, sol-gel, chemical vapor deposition, ultra violet curable resigns, and sputtering combinations comprising at least one of the foregoing application processes, and the like, may also be used.

Depending upon the application, or severity of service requirements, a plurality of different TBCs representing differing degrees of thermal conductivity may be applied to achieve an even temperature throughout each combustor panel. While the invention is taught using a combustor panel as the application substrate, other applications using other substrates that may experience similar temperature gradient related conditions are envisioned.

The low thermal conductivity TBC provides increased thermal insulation in hotter areas, which results in reduced base metal temperatures. The reduction in base metal temperatures reduces the potential oxidation of the metallic bondcoat, and ultimately the base alloy that comprises the combustor panel. In addition, the low thermal conductivity coating reduces the overall temperature difference between the hot spot locations and the cooler parts of the combustor panel that are coated with conventional TBCs, thereby increasing the durability of the TBCs. The reduction in temperature gradients between hot and cold areas reduces the potential for TMF cracking to occur in the part.

This invention mitigates combustor streaking caused by fuel nozzle coking, as well as hot spots following dilution holes.

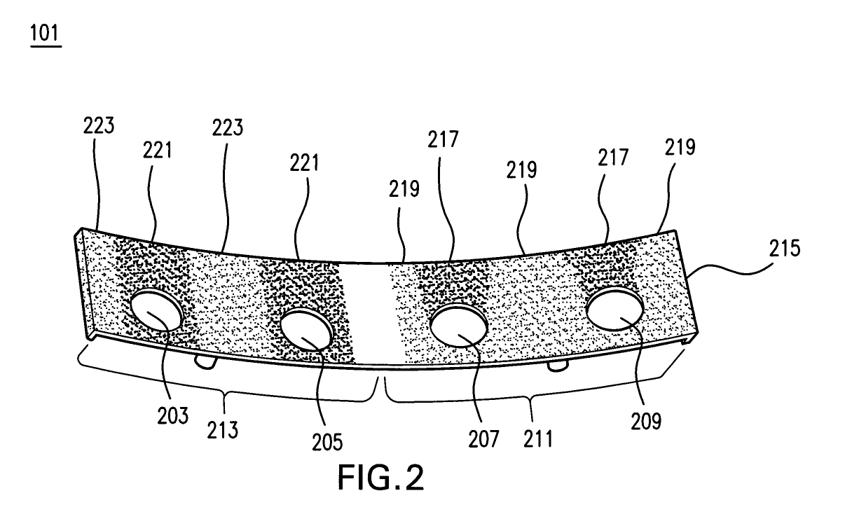

Shown in FIG. 2 is an exemplary combustor floatwall panel 101 inner surface with four dilution holes 203, 205, 207, 209. The panel 101 shows two sections for the purpose of teaching the invention. The first section 211 shows typical areas of distress 217 from hot spot formation downstream of two dilution holes 207, 209, and areas that have not experienced distress 219. The first section 211 shows a typical TBC 215 having a uniform thermal conductivity applied uniformly across the inner surface of the combustor panel 101. The second section 213 shows the different thermal conductivity TBCs of this invention applied to different areas of the combustor panel to maintain a uniform temperature across the panel 101. In the second section 213, TBCs having a higher thermal conductivity are applied to the areas that experience lower temperatures and less distress 223; and TBCs having a lower thermal conductivity are applied to the areas that experience higher temperatures and higher distress 221 proximate to dilution holes 203, 205.

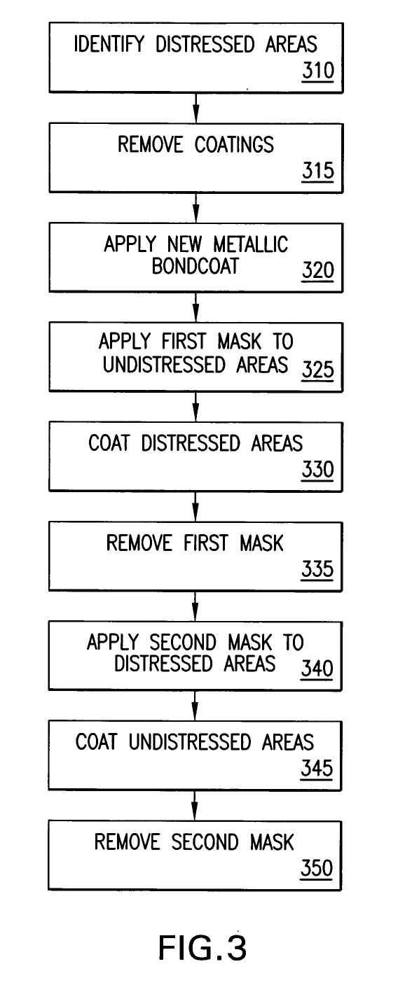

FIG. 3 shows one exemplary non-limiting method of the invention. Combustor panels 101 may be removed from a combustor 103 of a gas turbine engine previously in service, and be examined as part of a routine maintenance activity. The examination may include laying out the combustor panels 101 in a predetermined pattern and photographing them. The areas of distress typically manifest themselves as localized, visibly discolored hot spots or streaks 217 across inner panel surfaces. Any areas of distress that are identified may be photographed for distressed area definition, mask creation, and maintenance record keeping (step 310).

If a combustor panel 101 is being inspected as part of a routine maintenance activity, any previously applied coatings may need to be removed (step 315). The ceramic coating may be removed in any suitable manner, such as by using an aggressive grit blasting process, during which the uncoated areas of the panel may be masked. The metallic bondcoat may then be removed in any suitable manner, such as by acid etching. This may be performed using controlled conditions of acid concentration and temperature to achieve a controlled etching rate. Masks may be applied to the panels to protect uncoated areas, and then the panels 101 may be immersed in the acid bath for a predetermined amount of time to remove the metallic bondcoat.

If a combustor panel 101 is for a new engine, or is a replacement, coating removal (step 315) may not be necessary. Once any coatings are removed, if necessary, the combustor panel 101 surface may be prepared to receive a new metallic bondcoating, usually by a controlled grit blasting step, followed by ultrasonic cleaning in water to remove entrapped grit, and drying in a bakeout oven at temperatures above about 200° F. but below about 650° F. The metallic bondcoat is typically applied (step 320) by air plasma spraying, argon shrouded plasma spraying, vacuum plasma spraying, cathodic arc coating, diffusion coating, or high velocity oxy-fuel thermal spraying. A heat treatment, in some cases, may be used to improve the bonding between the metallic bondcoat and the base alloy. Heat treatment times of about 1 to 10 hours may be used at temperatures ranging from about 1,600 to 2,000° F. The surface of the metallic bondcoating may then be prepared in any suitable manner, such as by grit blasting, cleaning, and drying to receive a ceramic coating. In some cases, the metallic bondcoating may be peened to densify the metallic bondcoating prior to applying the ceramic coating, such as when the ceramic coating is to be applied by electron beam physical vapor deposition (EB-PVD) or other vapor deposition techniques.

The identified areas of distress 217 for a respective panel 101 may be used to create a respective mask that is drawn in conformance with the combustor panel 101 inner surface curvature as a conical section and comprises at least two different categories of areas. A first category area covers areas that have not experienced distress—undistressed areas 223. A second category area covers areas that have experienced, or may experience, distress—distressed areas 221. The mask (not shown) may be laser cut from photo dimensions captured during the identification step in conjunction with combustor panel CAD/CAM fabrication documents. The mask may be fabricated such that the interface between the undistressed areas 223 and distressed areas 221 is overlapped or blended to eliminate coating gaps between the areas 221, 223.

A first mask covering the undistressed areas 223 may be applied (step 325). The exposed area (i.e., distressed areas 221) of the combustor panel 101 inner surface may then be coated with a low thermal conductivity TBC (step 330). After coating the distressed areas 221, the first mask may be removed (step 335) and a second mask may be applied (step 340) to cover the distressed areas 221. A higher thermal conductivity coating may then be applied to the remaining exposed panel surface areas (i.e., undistressed areas 223) (step 345). The second mask may then be removed (step 350) and the combustor panel 101 may be inspected and installed in its respective position in its combustor.

The low thermal conductivity TBC and the higher thermal conductivity TBC may be applied in any suitable manner, such as by using EB-PVD or APS.

APS processes typically use a torch or gun which generates thermal and kinetic energy to apply a coating. The gun consists of an anode, a cathode, and gas and cooling flow channels. A large electrical potential is applied to the anode and cathode to generate an arc. A gas is passed through the gun at high pressure where it is ionized as plasma by the arc. Typical examples of gases that may be used include hydrogen, nitrogen, argon, helium and mixtures thereof. The plasma may have a temperature range from about 10,000 to 30,000° F. depending on the type and mixture of gases used. The gun typically includes a water jacket for cooling.

Ceramic powder(s) is injected into the plasma through powder ports located radially on the gun face and is carried downstream by the flowing plasma. During their short residence time, the ceramic particles are melted, accelerated, and impact the substrate to be coated forming a splat, or pancake-like deposit. Repeated impacts, from additional particles, continue to form splats, which build up to form the coating. Plasma spray can be accomplished in air, in a partial vacuum, or in a full vacuum depending on the coating materials and substrate material.

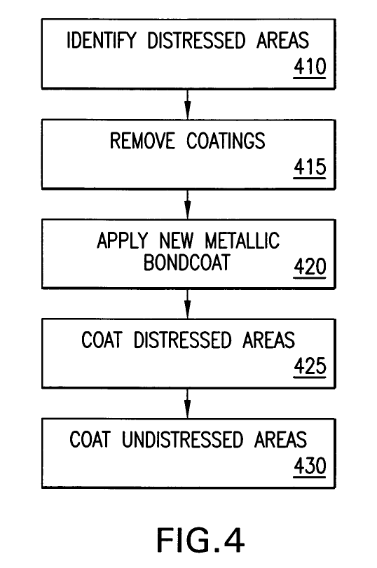

Shown in FIG. 4 is another exemplary non-limiting method of the invention. Rather than creating and applying masks to predetermined panel areas to selectively apply TBCs exhibiting different thermal conductivities, the equipment that controls and applies the TBCs may be programmed to coat predetermined panel areas with one or more different thermally conductive TBCs.

As described above, combustor panels 101 may be removed and examined as part of a routine maintenance activity, and areas of distress identified (step 410). Any previously applied coatings may need to be removed (step 415). The ceramic coating may be removed in any suitable manner, as described above. The metallic bondcoat may then be removed in any suitable manner, as described above.

Once any coatings are removed, if necessary, the combustor panel 101 surface may be prepared to receive a new metallic bondcoat, usually by a controlled grit blasting step, followed by ultrasonic cleaning in water to remove entrapped grit, and drying in a bakeout oven, as described above. The metallic bondcoat may then be applied (step 420), as described above.

The machinery used to apply the TBCs may be programmed to directly apply the low thermally conductive TBCs to the distressed areas 221 (step 425), and then to directly apply the higher thermally conductive TBCs to the undistressed areas 223 (step 430), or vice versa. For example, the plasma spray gun may be programmed to perform a spray pass over hot spot regions, leaving strips of low conductivity TBC in distressed areas 221 on the combustor panel 101 (step 425). The plasma spray fan pattern, as in most spray applications, tapers to zero thickness at an edge. The plasma spray gun may then apply the higher thermally conductive TBC in the undistressed areas 223 of the combustor panel 101 (step 430). The interface where two different TBC layers meet tapers together to create a mixed TBC zone, blending the interface between the two different TBCs to eliminate coating gaps therebetween. Depending on the order of application, a low thermally conductive TBC may be the bottom layer with the higher thermally conductive TBC on top, or vice versa.

The invention provides a unique TBC that reduces TBC spalling, minimizes TMF, and reduces base metal oxidation in combustor panel hot spots. The thermal protection is tailored to optimize part performance. The TBC does not require a part redesign and may be retrofitted to existing or legacy designs at OEM manufacture or during overhaul.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for obviating temperature gradients across a surface of a substrate comprising:
identifying distressed areas on the substrate;
applying a first mask to first areas of the substrate;
applying a first ceramic coating having a first predetermined thermal conductivity onto first unmasked areas of the substrate;
removing the first mask;
applying a second mask to second areas of the substrate;
applying a second ceramic coating having a second predetermined thermal conductivity onto second unmasked areas of the substrate; and
removing the second mask.

2. The method according to claim 1 wherein the first ceramic coating is applied by at least one of: electron beam physical vapor deposition and air plasma spraying.

3. The method according to claim 1 wherein the second ceramic coating is applied by at least one of: electron beam physical vapor deposition and air plasma spraying.

4. The method according to claim 2 further comprising removing any previously applied coatings before applying any masks.

5. The method according to claim 4 further comprising applying a metallic bondcoat to the substrate before applying any masks.

6. The method according to claim 5 wherein the metallic bondcoat is applied by at least one of: air plasma spraying, argon shrouded plasma spraying, vacuum plasma spraying, cathodic arc coating, high velocity oxygen fuel coating, and diffusion coating.

7. The method according to claim 5 further comprising preparing the surface of the metallic coating before applying the first and second ceramic coatings.

8. The method according to claim 7 wherein the first and second ceramic coatings have different thermal conductivities.

9. The method according to claim 1 wherein the first areas of the substrate comprise undistressed areas and the second areas of the substrate comprise distressed areas.

10. The method according to claim 9 wherein the first ceramic coating has a lower thermal conductivity than the second ceramic coating.

11. The method according to claim 1 wherein the first areas of the substrate are distressed areas and the second areas of the substrate are undistressed areas.

12. The method according to claim 11 wherein the first ceramic coating has a higher thermal conductivity than the second ceramic coating.

13. A method for obviating temperature gradients across a surface of a substrate comprising:
identifying distressed areas on the substrate;
applying a first ceramic coating having a first predetermined thermal conductivity onto first areas of the substrate; and
applying a second ceramic coating having a second predetermined thermal conductivity onto second areas of the substrate.

14. The method according to claim 13 wherein the first ceramic coating is applied by at least one of: electron beam physical vapor deposition and air plasma spraying.

15. The method according to claim 13 wherein the second ceramic coating is applied by at least one of: electron beam physical vapor deposition and air plasma spraying.

16. The method according to claim 14 further comprising removing any previously applied coatings before applying any ceramic coatings.

17. The method according to claim 16 further comprising applying a metallic bondcoat to the substrate before applying any ceramic coatings.

18. The method according to claim 17 wherein the metallic bondcoat is applied by at least one of: air plasma spraying, argon shrouded plasma spraying, vacuum plasma spraying, cathodic arc coating, high velocity oxygen fuel coating, and diffusion coating.

19. The method according to claim 18 further comprising preparing the surface of the metallic coating before applying the first and second ceramic coatings.

20. The method according to claim 19 wherein the first and second ceramic coatings have different thermal conductivities.

21. The method according to claim 13 wherein the first areas of the substrate comprise undistressed areas and the second areas of the substrate comprise distressed areas.

22. The method according to claim 21 wherein the first ceramic coating has a higher thermal conductivity than the second ceramic coating.

23. The method according to claim 13 wherein the first areas of the substrate are distressed areas and the second areas of the substrate are undistressed areas.

24. The method according to claim 23 wherein the first ceramic coating has a lower thermal conductivity than the second ceramic coating.

25. A turbine engine component comprising:
a substrate; and
at least two thermal barrier coatings, wherein each thermal barrier coating is deposited onto the substrate in a preselected area and each thermal barrier coating exhibits a different thermal conductivity.

26. The turbine engine component according to claim 25 wherein the thermal barrier coatings are applied by at least one of: electron beam physical vapor deposition and air plasma spraying.

27. The turbine engine component according to claim 26 further comprising a metallic bondcoat under the at least two thermal barrier coatings.

28. The turbine engine component according to claim 27 wherein the metallic bondcoat is applied by at least one of: air plasma spraying, argon shrouded plasma spraying, vacuum plasma spraying, cathodic arc coating, high velocity oxygen fuel coating, and diffusion coating.

29. The turbine engine component according to claim 28 wherein each preselected area of the substrate comprises undistressed and distressed areas.

30. The turbine engine component according to claim 29 wherein the thermal barrier coating on the undistressed areas has a higher thermal conductivity than the thermal barrier coating on the distressed areas.
